(19) United States
(12) Patent Application Publication
(10) Pub. No.: US 2026/0300679 A1
(43) Pub. Date: Oct. 1, 2026

(54) MODEL PROCESSING MODULE AND ELECTRONIC DEVICE

(71) Applicant: Lenovo (Beijing) Limited, Beijing (CN)

(72) Inventors: Xueli BAN, Beijing (CN); Zhijian MO, Beijing (CN); Qihua XIAO, Beijing (CN)

(21) Appl. No.: 19/574,082

(22) Filed: Mar. 20, 2026

(30) Foreign Application Priority Data
Mar. 31, 2025 (CN) 202510397892.1

(51) Int. Cl. G06N 3/02

(52) U.S. Cl. CPC G06N 3/02

(57) ABSTRACT

A model processing module includes a target memory storing a model set of a target model layer and an input data set, the model set including at least one model data, the input data set including at least one input data; a first access control module configured to obtain first data of a first data type from the target memory; a second access control module configured to obtain second data of a second data type from the target memory; a third access control module configured to obtain third data of the second data type from the target memory; a first processor configured to determine first output data of the target model layer based on the first data and the second data; and a second processor configured to determine second output data of the target model layer based on the first data and the third data.

### CROSS-REFERENCES TO RELATED APPLICATION

This application claims priority to Chinese Patent Application No. 202510397892.1 filed on Mar. 31, 2025, the entire content of which is incorporated herein by reference.

### FIELD OF TECHNOLOGY

The present disclosure relates to the field of computer technology and, more specifically, to a model processing module and an electronic device.

### BACKGROUND

The use of artificial intelligence chips, such as neural network processors, to perform data processing related to artificial intelligence (AI) models, such as neural network models, is becoming increasingly common.

However, the efficiency of using AI chips to process data related to AI models is relatively low.

### SUMMARY

One aspect of this disclosure provides a model processing module. The model processing module includes a target memory, a first access control module, a second access control module, a third access control module, a first processor, and a second processor. The target memory is used to store a model set of a target model layer to be processed in the processing module and an input data set to be processed by the target model layer, the model set including at least one model data, the input data set including at least one input data. The first access control module is configured to obtain first data of a first data type from the target memory, the first data type being either the model data or the input data. The second access control module is configured to obtain second data of a second data type from the target memory, the second data type being either the model data or the input data, the second data type being different from the first data type. The third access control module is configured to obtain third data of the second data type from the target memory. The first processor is configured to determine first output data of the target model layer based on the first data and the second data. The second processor is configured to determine second output data of the target model layer based on the first data and the third data.

Another aspect of this disclosure provides an electronic device. The electronic device includes a model processing module. The model processing module includes a target memory, a first access control module, a second access control module, a third access control module, a first processor, and a second processor. The target memory is used to store a model set of a target model layer to be processed in the processing module and an input data set to be processed by the target model layer, the model set including at least one model data, the input data set including at least one input data. The first access control module is configured to obtain first data of a first data type from the target memory, the first data type being either the model data or the input data. The second access control module is configured to obtain second data of a second data type from the target memory, the second data type being either the model data or the input data, the second data type being different from the first data type. The third access control module is configured to obtain third data of the second data type from the target memory. The first processor is configured to determine first output data of the target model layer based on the first data and the second data. The second processor is configured to determine second output data of the target model layer based on the first data and the third data.

Another aspect of this disclosure provides a model processing method. The model processing method includes, storing, by a target memory, a model set of a target model layer to be processed in the processing module and an input data set to be processed by the target model layer, the model set including at least one model data, the input data set including at least one input data; obtaining, by a first access control module, first data of a first data type from the target memory, the first data type being either the model data or the input data; obtaining, by a second access control module, second data of a second data type from the target memory, the second data type being either the model data or the input data, the second data type being different from the first data type; obtaining, by a third access control module, third data of the second data type from the target memory; determining, by a first processor, first output data of the target model layer based on the first data and the second data; and determining, by a second processor, second output data of the target model layer based on the first data and the third data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to provide a clearer illustration of various embodiments of the present disclosure or technical solutions in conventional technology, the drawings used in the description of the disclosed embodiments or the conventional technology are briefly described below. The following drawings are merely embodiments of the present disclosure. Other drawings may be obtained based on the disclosed drawings by those skilled in the art without creative efforts.

FIG. 1 is a schematic structural diagram of a model processing module according to some embodiments of the present disclosure.

FIG. 2 is a schematic structural diagram of the model processing module according to some embodiments of the present disclosure.

FIG. 3 is a schematic diagram of an input data set needed for a target model layer and an output data set obtained based on the target model layer according to some embodiments of the present disclosure.

FIG. 4 is a schematic diagram of a first input data subset and a second input data subset according to some embodiments of the present disclosure.

FIG. 5 is a schematic diagram of a processor in the model process module performing operations on the input data and model data according to some embodiments of the present disclosure.

FIG. 6 is a schematic structural diagram of the model processing module according to some embodiments of the present disclosure.

FIG. 7 is a schematic diagram of an implementation principle for processing the first output data of 6×6 dimensions into first target output data of 8×8 dimensions according to some embodiments of the present disclosure.

FIG. 8 is a schematic diagram of a component architecture of the model processing module in an application scenario according to some embodiments of the present disclosure.

FIG. 9 is a schematic structural diagram of an electronic device according to some embodiments of the present disclosure.

### DETAILED DESCRIPTION

The following describes the embodiments of the present disclosure with reference to the accompanying drawings. The terms used in the embodiments of the present disclosure are only used to explain the specific embodiments of the present disclosure, and are not intended to limit the present disclosure. One of ordinary skill in the art may learn that, with technology development and emergence of a new scenario, the technical solutions provided in embodiments of the present disclosure are also applicable to a similar technical problem.

In this specification, claims, and accompanying drawings of the present disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having a same attribute in embodiments of the present disclosure. In addition, the terms “include”, “contain” and any other variants mean to cover the non-exclusive inclusion such that a process, method, system, product, or device that includes a series of units is not necessarily limited to those units, but may include other units not expressly listed or inherent to such a process, method, system, product, or device.

The following describes the model processing module in the present disclosure. In the present disclosure, the model processing module can be a chip used for processing artificial intelligence-related computing tasks, or a module within an integrated circuit such as a System on Chip (SOC) or an AI chip, for processing artificial intelligence-related computing tasks, which is not limited in the present disclosure.

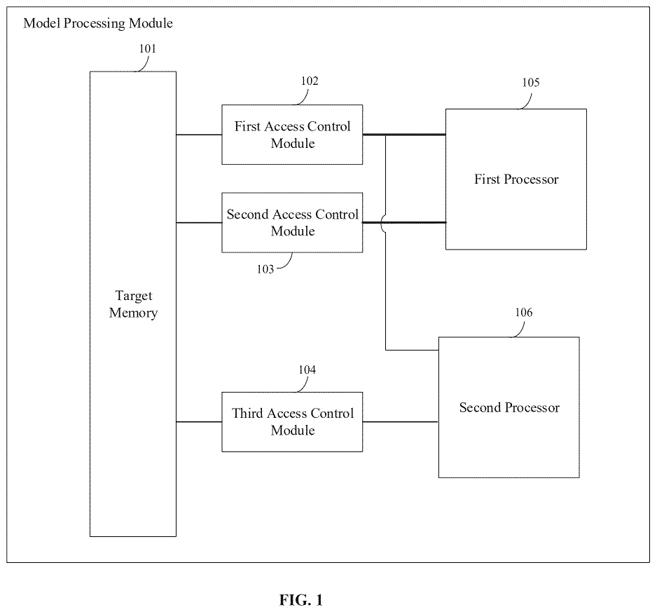

FIG. 1 is a schematic structural diagram of a model processing module according to some embodiments of the present disclosure.

As shown in FIG. 1, the model processing module includes a target memory 101, a first access control module 102, a second access control module 103, a third access control module 104, a first processor 105, and a second processor 106.

In some embodiments, the target memory 101 may be used to store a set of target model layers to-be-executed in the processing model and a set of input data to be processed by the target model layers.

The processing model can be a neural network model or other artificial intelligence models with multiple hierarchical structures. The specific processing model will vary depending on the actual task and inference scenario, which is not limited in the present disclosure.

It should be understood that a processing model generally consists of at least one model module, with each model module representing a model layer. When performing task inference based on a processing model, the input data needs to be fed sequentially into each model module of the processing model for processing. In the present disclosure, for ease of distinction, the model module that the model processing module needs to run is referred to as the target model layer. For example, if the processing module is a convolutional neural network model, and the convolutional neural network includes multiple convolutional layers, then the input data needs to be processed sequentially based on each convolutional layer. Therefore, the currently running convolutional layer is the target model layer.

In some embodiments, the model set may include the collection of model data involved in the calculations within the target model layer of the processing model. Therefore, the model set includes at least one model data. For example, the model data in a model set can include parameter data such as the weight matrices of the target model layer; correspondingly, this model set is also a data matrix.

In some embodiments, the input data set may include at least one input data, and the input data set may consist of the input data that needs to be processed by the target model layer. For example, if the target model layer is the first model layer in the processing model, then the input data set may be the set of input data that needs to be fed into the processing model. If the target model layer is an intermediate model layer in the processing model, then the input data set corresponding to the target model layer may be the data set output from the previous model layer in the processing model after computation and processing. In the present disclosure, the input data set processed by the processing model may be vector data corresponding to an image or a text, or other forms of data matrices, which are not limited in the present disclosure.

In the present disclosure, the target memory can take various forms. For example, the target memory can be a Static Random-Access Memory (SRAM).

In some embodiments, the first access control module 102 may be used to obtain first data of a first data type from the target memory. The first data type may be used to indicate whether the data belongs to model data or input data; therefore, the first data type can be either model data or input data. For example, if the first data type is model data, then the first data belongs to the input data within the model set.

In some embodiments, the second access control module 103 may be used to obtain second data of a second data type from the target memory. The second data type may be used to indicate whether the data belongs to model data or input data; therefore, the second data type can be either model data or input data. The second data type may be different from the first data type. For example, if the first data type is model data, then the second data type is input data, and the second data belongs to input data of the input data set.

In some embodiments, the third access control module 104 may be used to obtain third data of the second data type from the target memory.

In the present disclosure, the third data and the second data may be different data of the same data type. For example, if the second data type is model data, then the second data and the third data may be different model data within a model set.

In the present disclosure, the first access control module, the second access control module, and the third access control module may have a direct or indirect data connection with the target memory.

In some embodiments, the first processor 105 may be used to determine the first output data of the target model layer based on the first data and the second data.

In some embodiments, the second processor 106 may be used to determine the second output data of the target model layer based on the first data and the third data.

In some embodiments, the first processor may be directly connected to the first access control module and the second access control module, or indirectly connected through other data transmission modules, or the connection may be established or disconnected under register control. Similarly, the second processor may be connected directly or indirectly to the first access control module and the third access control module.

In some embodiments, the first processor and the second processor may be processors or processor cores capable of running artificial intelligence models. The present disclosure does not limit the type of processor for either the first processor or the second processor. For example, the first processor and the second processor may be neural network processing units (NPUs) or NPU cores, or the first processor and the second processor may be CPUs, CPU cores, or other types of processing units.

It can be understood that, since the time it takes to read data from the target memory is relatively long, therefore, the data reading efficiency of reading the model data of the to-be-executed target model layer in the processing model and the required input data from the target memory is an important factor that limits the processing efficiency of the processor performing calculations on data related to the target model layer. In the present disclosure, the model processing module includes two processors used for running the processing model. In this way, the two processors can read their respective required data of the second data type from the target memory in parallel, thereby improving data reading efficiency.

In addition, considering that the target memory has a fixed data read bandwidth, the first processor and the second processor in the present disclosure may share the first data of the first data type obtained by the first access control module. This allows the first data obtained by the first access control module to be transmitted to the first processor while simultaneously mirroring the first data to the second processor, thereby eliminating the need for both processors to retrieve the first data separately from the target memory. This naturally reduces the amount of data that needs to be read from the target memory and decreases the number of data reading operations.

In some embodiments, the first data type may be set based on actual needs. For example, if the first data type is input data, then the first access control module can transmit the input data to the first processor while simultaneously mirroring the corresponding input data to the second processor. In some embodiments, the first processor and the second processor can receive the same input data, but the model data may be different. For example, if the first data type is model data, then this is equivalent to transmitting the model data obtained by the first access control module to the first processor while simultaneously mirroring the model data to the second processor. Therefore, the input data for the first processor and the second processor are different, but the model data is the same.

Since both the first processor and the second processor can obtain the first data from the target memory through the first access control module, and the first processor and the second processor need to process the same type of data of the first data type. However, the first processor and the second processor can obtain different data of the second data type through different access control modules. This allows the first processor and the second processor to be responsible for processing different data of the first data type and the second data type, respectively. In this way, the first processor and the second processor can simultaneously perform calculations on different input data and model data.

It can be understood that, in the process of processing input data based on the target model layer, there is a need to sequentially perform calculations on each model data of the target model layer with each input data. For example, there is a need to perform multiplication and addition operations between the model data in each target model layer and the corresponding input data, in order to obtain the output data after the target model layer processes the input data set. Based on this, in the present disclosure, while maintaining the first data of the first data type to be the same in both processors, the two processors can perform operations on different types of the first data and the second data, respectively. In this way, two processors can be used to process each model data against each input data. That is, data calculations for the target model layer can be completed using two processors.

It can be understood that the first processor and the second processor may each include at least one processing unit. For example, when the first processor and the second processor are NPUs, each NPU may include 16 multiply accumulate (MAC) units. Based on this, the first data in the present disclosure may include at least one first array. The number of arrays may be the same as the number of processing units in the first processor (or the second processor), and the dimension of each array may be determined by the number of bits supported by the processing unit. For example, if each processing unit supports operations between 32-bit data, then each element of the array will be 32-bit data. Similarly, the second data set may include at least one second array, and the third data set may include at least one third array. The number of second arrays in the second data set and the number of third arrays in the third data set may both be equal to the number of first arrays in the first data set.

Consistent with the present disclosure, the model processing module can have a first processor and a second processor. Since the first data of the first data type obtained by each processor is the same, while the data of the second data type is different, the two processors can respectively handle the computation and processing of different data types of the first data type and the second data type, thereby jointly completing the data computation and processing related to the target model layer in the processing model. Based on this, since the two processors can simultaneously read different data of the second data type from the target memory through different access control modules, data can be read from the target memory more efficiently. In addition, considering the limitations of the data read bandwidth of the target memory, both the first processor and the second processor in the present disclosure can obtain the first data of the first data type read from the target memory by the first access control module. This allows the two first processors to read the required first type of data from the target memory only once, naturally reducing the amount of data read from the target memory and improving data reading efficiency. By improving the data reading efficiency of the two processors, the situation where the processing model cannot perform calculations on relevant data in a timely manner due to low data reading speed can be reduced. This naturally improves the processing efficiency of the model processing module in performing calculations on the relevant data.

It can be understood that, in the present disclosure, the first data type and the second data type can be set based on actual needs, which allows the first processor and the second processor to share the input data or model data read by the first access control module.

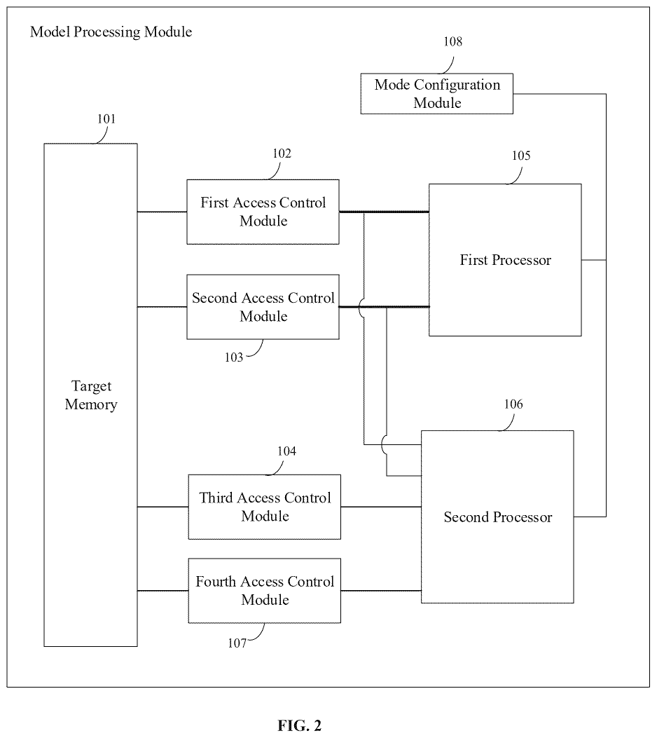

In order to more flexibly control the data types of the data that can be shared between the first processor and the second processor, in the present disclosure, the model processing module may also include a fourth access control module. FIG. 2 is a schematic structural diagram of the model processing module according to some embodiments of the present disclosure.

As shown in FIG. 2, in addition to the target memory 101, the first access control module 102, the second access control module 103, the third access control module 104, the first processor 105, and the second processor 106, the model processing module also includes a fourth access control module 107.

Based on this, the model processing module in the present disclosure can support two modes.

In the first mode, the third access control module can be used to obtain the third data, and the second processor can obtain the first data from the first access control module and the third data from the third access control module. Correspondingly, in the first mode, the second processor can determine the second output data of the target model layer based on the first data and the third data.

It can be seen that, in the first mode, the first processor and the second processor can share the first data of the first data type, but the data of the second data type obtained by the first processor and second processor are different.

In some embodiments, in the first mode, the fourth access control module may not be operational, and the second processor may not read data from the target memory through the fourth access control module.

In the second mode, the fourth access control module 107 may be used to obtain fourth data of the first data type from the target memory. In addition, in the second mode, the second processor can obtain the second data from the second access control module and the fourth data from the fourth access control module, and based on the second and fourth data, determine the third output data of the target model layer.

In some embodiments, the fourth access control module may have a data connection with the second processor either directly or indirectly through a bus or other devices.

It can be understood that, in order for the second processor to communicate with either the first access control module or the second access control module in different modes, there is a direct or indirect data connection between the second processor and both the first access control module and the second access control module. Of course, the data connection path between the second processor and the first access control module and the second access control module may be a controllable data connection path that can be connected or disconnected as needed.

In order to distinguish it from the second output data determined by the second processor in the first mode, in the present disclosure, the output data of the target model layer determined by the second processor based on the second data and the fourth data is referred to as the third output data.

It can be understood that, in the second mode, the third access control module may not be operational. In this case, the first processor and the second processor may obtain different types of data for the first data type, but the first processor and the second processor may share the second data of the second data type.

There are various possible implementations for controlling the model processing module operating in either the first mode or the second mode, which is not limited in the present disclosure.

In some embodiments, as shown in FIG. 2, the model processing module may also include a mode configuration module 108.

In some embodiments, the mode configuration module 108 may be used to receive a mode indication instruction sent by a controller, the mode indication instruction indicating whether the model processing module is in the first mode or the second mode. In response to the mode indication instruction being an instruction to activate the first mode, the mode configuration module may instruct the second processor to access the first access control module and the third access control module; in response to the mode indication instruction being an instruction to activate the second mode, the mode configuration module may instruct the second processor to access the second access control module and the fourth access control module.

In some embodiments, the controller may be a processor or control device that is external to the model processing module and capable of issuing control instructions to the model processing module. For example, if both the first processor and the second processor are NPUs, the controller may be a central processing unit (CPU), etc.

In some embodiments, the mode configuration module may be configured to establish a communication connection with the first processor and the second processor directly or indirectly via a bus or other communication methods.

In some embodiments, the mode configuration module may be used to control and manage the operating modes, resource scheduling, and configuration parameters of the first processor and the second processor. For example, the mode configuration module may be used to configure the control registers in the model processing module.

It can be understood that, with the first data type and the second data type being fixed, switching between the first mode and the second mode allows for changing the data types that the first processor and the second processor can share. This allows for more flexible selection of whether to mirror the input data or the model data, based on the amount of data in the input data and the model data in the target model layer.

For example, in some embodiments, the first data type is model data. Based on this, the first data is the first model data, the first model data belonging to at least one model data in the model set of the target model layer. Correspondingly, the second data type is input data. Based on this, the second data is the first input data, the first input data belonging to at least one input data within the input data set.

Based on this, in the first mode, the third data that the third access control module obtains from the target memory may be the second input data, the second input data belonging to at least one input data in the input data set.

In the second mode, the fourth data that the fourth access control module obtains from the target memory may be the second model data, the second model data belonging to at least one model data in the model set in the target model layer.

In some embodiments, as shown in FIG. 2, in the first mode, after the first access control module obtains the first model data, the first access control module can transmit the first model data to the first processor while simultaneously mirroring the first model data to the second processor. This eliminates the need for the second processor to read the first model data from the target memory via the fourth access control module, thereby avoiding the situation where two processors repeatedly read the same first model data from the target memory, which naturally improves data reading efficiency. Correspondingly, in the second mode, after receiving the first input data, the second access control module can transmit the first input data to the first processor and simultaneously mirror the first input data to the second processor. This eliminates the need for the second processor to read the first input data from the target memory via the third access control module.

As described above, the first model data may include at least one first array. The number of the first array may be related to the number of processing units in the first processor. The first array may be an array composed of model data, and the number of bits in the model data within the first array may be related to the number of bits supported by the first processor. For details of the first array, reference can be made to the relevant description provided above, which will not be repeated here. Similarly, the first input data may include at least one second array. The second array may be an array composed of the input data. The second input data may include at least one third array, and the third array may be an array composed of input data, the third array being different from the second array. The second model data may include at least one fourth array, and the fourth array may be an array composed of model data, the fourth array being not entirely identical to the model data in the first array. The bits of the data in the second array, third array, and fourth array may be the same as the bits in the first array, and details will not be described here.

It should be understood that, in the first mode, the first processor and the second processor need to obtain different data of the second data type from the target memory through different data access modules. In order to enable the two processors to accurately obtain different data belonging to the second data type through different data access modules, the controller may also pre-split the data of the second data type into two subsets of the first data type, and store the two subsets of the first data type separately in a first memory corresponding to the first processor and a second memory corresponding to the second processor in the target memory.

Similarly, in the second mode, the electronic device may also split the data of the first data type into two subsets of the second data type, and store the two subsets of the second data type separately in the first memory corresponding to the first processor and the second memory corresponding to the second processor in the target memory.

The following description takes the first data type being the model data as an example.

In the first mode, the first processor and the second processor can share the first model data, therefore, the input data set can be split into a first input data subset and a second input data subset by a controller outside the model processing module. The first input subset can be stored in the first memory of the target memory corresponding to the first processor, and the second input subset can be stored in the second memory of the target memory corresponding to the second processor. The first input data subset and the second input data subset may not be completely identical, and the first input data subset and the second input data subset together constitute the input data set.

The purpose of the controller splitting the input data set is to feed different parts of the input data set to the first and second processors for computation and processing.

The specific method for the controller to split the input data set can be determined based on practical needs, controlled by an appropriate splitting algorithm, as long as each resulting subset of input data can be processed with the model data in the target model layer.

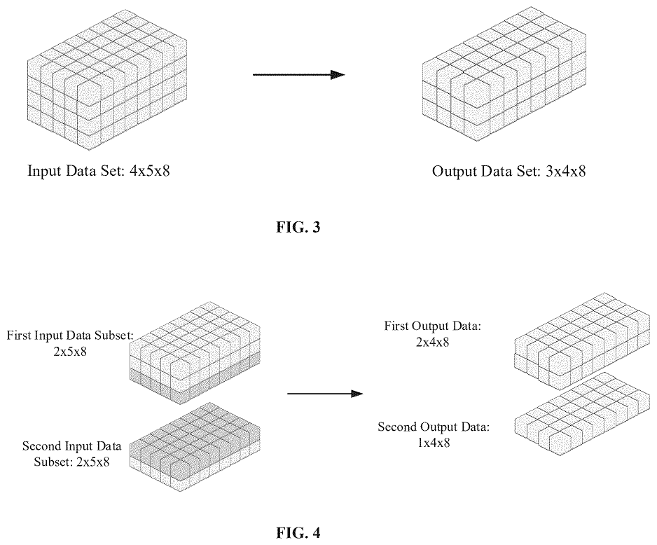

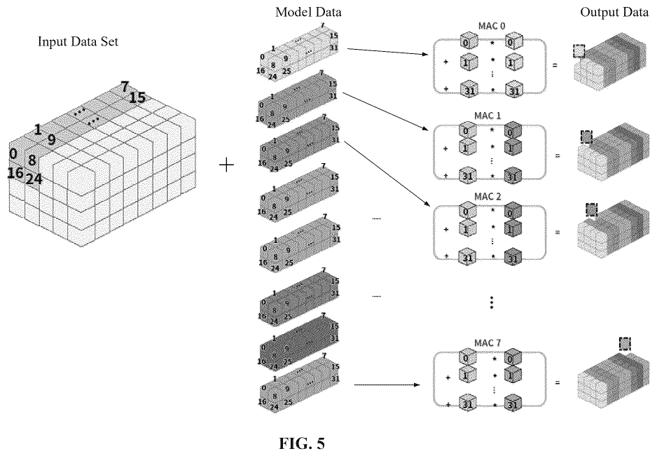

For ease of understanding, an example is provided below in conjunction with FIG. 3 and FIG. 4.

FIG. 3 is a schematic diagram of an input data set needed for the target model layer and an output data set obtained based on the target model layer according to some embodiments of the present disclosure, and FIG. 4 is a schematic diagram of the first input data subset and the second input data subset split from the input data set in FIG. 3.

In FIG. 3 and FIG. 4, both the input data set and output data sets are data matrices, with data dimensions represented by length×width×depth. In FIG. 3, the data set to the left of the arrow is the input data set that needs to be processed based on the target model layer. This input data set has dimensions of 4×5×8, where 4 corresponds to length (or height), 5 corresponds to width, and 8 corresponds to depth. Therefore, this input data set corresponds to 0-159 bits of data. Correspondingly, the output data set obtained by processing the input data set based on the target model layer has a dimension of 3×4×8, and the size of the output data set is 96 bits.

On the basis of FIG. 3, assume that at each processing unit in the first processor and the second processor reads the first model data with a data dimension of 2×2×8, then the input data set in FIG. 3 can be switched to the first input data subset and the second input data subset shown in FIG. 4.

As shown in FIG. 4, the first input data subset has a dimension of 3×5×8, therefore, the first input data subset consists of 120 bits of data. To ensure that 2×2×8 data can be extracted from the second input data subset for matrix multiplication and other operations with the first model data, the length and width of the second input data subset should not be less than 2×2. Based on this, the second input data subset may have some data overlapping with the first input data subset, such as the dark gray area represents the overlapping data between the first and second input data subsets shown in FIG. 4. Based on this, the data dimensions of the second input data subset are 2×5×8. Correspondingly, the first processor performs calculations on the input data from the first input subset and the model data from the model set of the target model layer to obtain the first output data shown in FIG. 4. Similarly, the second processor can obtain the second output data.

The first output data and the second output data together actually constitute the output data shown in FIG. 3. For example, in FIG. 4, the first output data is 64 bits, with a dimension of 2×4×8, while the second output data is 32 bits, with a dimension of 1×4×8. Therefore, combining the first and second output data results in the output data with a dimension of 3×4×8 as shown in FIG. 3.

Of course, FIG. 3 is merely an example, and the present disclosure does not limit the specific switching methods and control mechanisms used by the controller outside the model processing module for splitting the input data set.

Based on the above, in the first mode, the target memory can be used to store, in the first memory corresponding to the first processor, the set of model layers of the target model layer to be executed in the processing model, and the first subset of input data to be processed by the target model layer. In addition, the second input data subset to be processed by the target model layer can be stored in the second memory corresponding to the second processor.

Further, in the first mode, the first access control module can be used to obtain the first model data from the model set in the first memory of the target memory; the second access control module can be used to obtain the first input data from the first input data subset in the first memory; and the third access control module can be used to obtain the second input data from the second input data subset in the second memory of the target memory.

Continue with the first data type being the model data as an example. In the second mode, the first processor and the second processor can share the first input data, therefore, model set can be split into a first subset of models and a second subset of models by a controller outside the model processing module, and the first and second subsets of models can be stored in the first memory and the second memory, respectively. The first subset of models and the second subset of models together may form the model set for the target model layer. Based on this, in the second mode, the target memory can be used to store the first subset of models of the target model layer to be executed in the processing model and the input data to be processed by the target model layer in the first memory corresponding to the first processor, and to store the second subset of models of the target model layer in the second memory corresponding to the second processor.

Correspondingly, in the second mode, the first access control module can be used to obtain the first model data from the first subset of models in the first memory; the second access control module can be used to obtain the first input data from the input data set in the first memory; and the fourth access control module can be used to obtain the second model data from the second subset of models in the second memory.

It can be understood that, in the present disclosure, controlling whether the model processing module enters the first mode or the second mode can be predetermined or selected manually as needed. Generally, the amount of data in the model set of the target model layer is relatively small compared to the amount of data in the input data set corresponding to that target model layer. Therefore, in most cases, the cache space of the processing units of both the first and second processors is sufficient to accommodate the model data in the model set of the target model layer.

Based on this, when the first data type is model data, if the amount of data in the model set of the target model layer is not greater than the cache space of the processing unit in the first processor (or the second processor), the model set may not be split. Therefore, the controller can control the model processing module to be in the first mode. That is, when the first data type is model data, the mode indicating instruction of activating the first mode can indicate that the amount of data in the model set of the target model layer is no greater than the cache space of the processing unit in the first processor. Conversely, the mode indicating instruction of activating the second mode can indicate that the amount of data in the model set of the target model layer is greater than the cache space of the processing unit in the first processor.

For ease of understanding, the process of the first processor and the second processor performing data operations on the target model layer in parallel will be described below with reference to FIG. 5. FIG. 5 is a schematic diagram of a processor in the model process module performing operations on the input data and model data according to some embodiments of the present disclosure.

In FIG. 5, the processor is shown including 8 processing units, and it is assumed that each processing unit is a multiply-accumulate (MAC) unit. For ease of description, FIG. 5 only illustrates the computation process performed by a single processor. Assume that the two processors process different input data but use the same model data, then the computation process performed by the different processors is identical except for the input data.

Since each data point in the input data set needs to be multiplied and added with each data in the model set, the input data to each MAC unit in the input processor shown in FIG. 5 can be the same, but each MAC unit processes different model data.

Based on this, a 2×2×8 input data set can be extracted from the input data, with the input data being 32 bits. As shown in the FIG. 5, the input data required for each MAC unit in the processor is the data covered by the green area in the input data set. Correspondingly, 8 sets of model data need to be extracted from the model set of the target model layer. Each set of model data is also 2×2×8 data, therefore, each set of model data is also 32 bits of data. As shown in FIG. 5, multiple three-dimensional data matrices of different colors represent different model data.

Each MAC unit in the processor performs matrix multiplication and addition operations on the input data and model data. Ultimately, the output data from these 8 MAC units can form the input data for the green section, which is then used in calculations with different model data in the target model layer to generate the final output data. In FIG. 5, different layers of the output data on the right are represented by different colors, and each color corresponds to a layer representing the result obtained by performing matrix multiplication and addition operations between the model data corresponding to that color and the input data.

Therefore, it can be seen that the input data processed by all 8 MAC units are the same, while the model data processed by each unit are different. However, each MAC unit can independently perform matrix multiplication and addition operations, and the output data from each MAC unit can be combined to form the final output data.

In some embodiments, if there are two processors, then each MAC unit in both processors can process the same input data, but process different model data. In this way, the matrix multiplication and addition operations between the input data of the green section and the 18 different sets of model data can be completed in parallel by two processors.

It can be understood that, after processing the input data in the green section of the input data set shown in FIG. 5 with all the models in the model set, the next set of input data to be processed can be taken from the input data set, and the above operations can be repeated until every input data point in the input data set has been processed with every model data in the model set through multiplication and addition operations.

The access control module described in the present disclosure can take various forms, which is not limited in the present disclosure.

In some embodiments, to ensure that the data obtained by the access control module is input to the various processing units of the processor in a first-in, first-out (FIFO) manner, each access control module in the present disclosure may include an access storage controller, a FIFO module, and a parameter receiving controller.

In some embodiments, the access storage controller may be responsible for reading data from the target memory and transferring that data from the target memory to the processor.

In some embodiments, the FIFO module may be used to buffer the data read by the access storage controller from the target memory in sequence, allowing the processor to retrieve the data based on the FIFO principle.

In some embodiments, the parameter receiving controller may be used to retrieve data from the FIFO module and transfer it to the processor, ensuring the correctness and timeliness of data calculations.

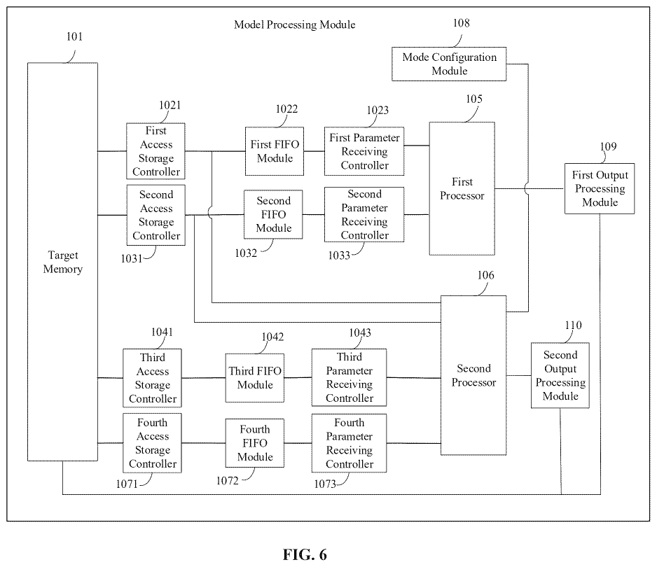

FIG. 6 is a schematic structural diagram of the model processing module according to some embodiments of the present disclosure.

In FIG. 6, the first access control module includes a first access storage controller 1021, a first FIFO module 1022, and a first parameter receiving controller 1023; the second access control module includes a second access storage controller 1031, a second FIFO module 1032, and a second parameter receiving controller 1033; the third access control module includes a third access storage controller 1041, a third FIFO module 1042, and a third parameter receiving controller 1043; the fourth access control module includes a fourth access storage controller 1071, a fourth FIFO module 1072, and a fourth parameter receiving controller 1073.

Based on this, in the first mode, the second processor 106 can obtain the first data from the first access storage controller 1021 through the fourth FIFO module 1072 and the fourth parameter receiving controller 1073. For example, if the first data type is model data, then the first data is the first model data.

In the second mode, the second processor 106 can obtain the second data from the second access storage controller 1031 through the third FIFO module and the third parameter receiving controller.

For example, the first access storage controller 1021, in addition to establishing a data connection with the first FIFO module 1022, can also establish a data connection with the fourth FIFO module 1072. Based on this, after the first storage controller obtains the first data of the first data type from the target memory, it can not only transmit the first data to the first processor through the FIFO module, but also transmit a mirrored copy of the first data to the fourth FIFO module. In this way, the second processor can also obtain the first data.

Similarly, the second access storage controller 1031, in addition to establishing a data connection with the second FIFO module 1032, can also establish a data connection with the third FIFO module 1042. In this way, the second processor can also obtain the second data read from the target memory by the second access storage controller.

For the functions and other information of other components in FIG. 6, reference can be made to the relevant description in the foregoing embodiments, which will not be repeated here.

It should be understood that, in any of the above embodiments, the output data obtained by processing the input data set based on the target model layer is actually the input data for the next model layer of that target model layer. However, the first output data and the second output data obtained from the first and second processors may not match the target data dimensions corresponding to the model data in the next model layer. This prevents direct computation between the first output data and second output data and the model data in the next model layer.

Based on this, the model processing module may also include a first output processing module and a second output processing module.

Based on this, the first processor may be further configured to output the first output data to the first output processing module, determine the target data dimension corresponding to the model set in the next model layer after the target model layer in the processing model, and send the target data dimension to the first output processing module. The first output processing module may be configured to process the first output data into the first target output data with the target data dimension.

Similarly, the second processor may be further configured to output the second output data to the second output processing module, determine the target data dimension corresponding to the model set in the next model layer, and send the target data dimension to the second output processing module. The second output processing module may be configured to process the second output data into the second target output data with the target data dimension.

The next model layer may be the model layer that follows the target model layer in the model. The model set of the next model layer may include at least one model parameter involved in the computation of that next model layer, such as model data of weight data in the next model layer. For ease of distinction, the model set in the target model layer can be referred to as the first model set, while the model set in the next model layer can be referred to as the second model set.

In addition, in order for the processor to read the relevant data required for computation from the target memory when processing the next model layer, the first output processing module may also be used to store the first target output data in the target memory such as storing the first target output data in the first memory of the target memory. Similarly, the second output processing module may also be used to store the second target output data into the target memory such as storing the second target output data in the second memory of the target memory.

For ease of understanding, take the model processing module shown in FIG. 6 as an example. As shown in FIG. 6, the first processor 105 is also connected to a first output processing module 109, and the second processor 106 is also connected to a second output processing module 110.

In addition, the first output processing module 109 and the second output processing module 110 may also have direct or indirect data connection channels with the target memory 101. Based on this, the first output processing module can store the first target output data in the target memory, and the second output processing module can also store the second target output data in the target memory.

In some embodiments, the model processing module can operate in the first mode and the second mode. In both the first and second modes, the first processor outputs the same first output data to the first output processing module. Correspondingly, the first output processing module processes the data to generate the same first target transmission data. However, the specific operations of the second processor and the second output processing module may differ in the first and second modes.

Specifically, in the first mode, the second processor outputs the second output data to the second output processing module and sends the target data dimension to the second output processing module. Correspondingly, the second output processing module is used to process the second output data into second target output data with the target data dimension.

In the second mode, the first processor may be further configured to output the third output data to the second output processing module, determine the target data dimension corresponding to the model set in the next model layer, and send the target data dimension to the second output processing module. Correspondingly, the second output processing module may be used to process the third output data into the third target output data with the target data dimensions.

In the present disclosure, since both the first output processing module and the second output processing module can be implemented in hardware, the alignment of output data with the data dimensions of the model set in the next model layer can be achieved through hardware, thereby effectively utilizing the inherent characteristics of the hardware for more efficient data dimension alignment.

In some embodiments, the first output processing module may be configured to construct a first all-zero matrix of the target data dimension. Based on the positions in the first all-zero matrix corresponding to each data point in the first output data, each data point in the first output data can be filled into the corresponding position in the first all-zero matrix, resulting in the first target output data. Therefore, the first target output data is data with the same dimensions as the target data. An all-zero matrix can refer to a matrix where all the values at every position are zero.

Similarly, the first output processing module may be configured to construct a second all-zero matrix of the target data dimension. Based on the positions in the second all-zero matrix corresponding to each data point in the second output data, each data point in the second output data can be filled into the corresponding position in the second all-zero matrix.

It should be understood that both the first output data and the second output data may also be matrix data. In addition, when determining the first output data, the storage space occupied by each data element within the first output data in the target memory is fixed, and the number of bits in the storage space is the same as the number of bits corresponding to the target data dimension of the data. Therefore, it is possible to determine which position in the target data dimension corresponds to each data point in the first output data. However, since the dimensionality of the first output data may not match the dimensionality of the data in the model set of the next model layer, the bits corresponding to each data point in the first output data may not be continuous.

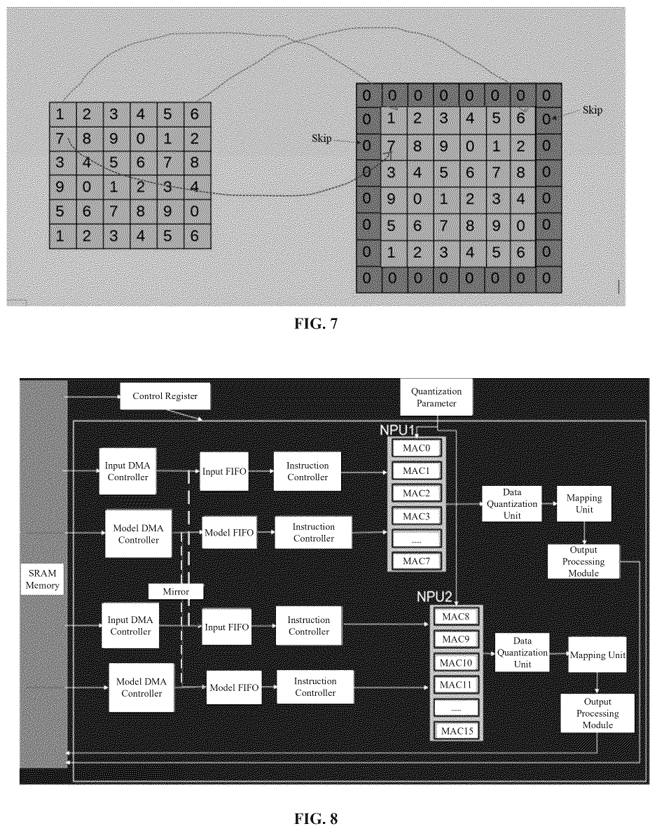

For ease of understanding, refer to FIG. 7. FIG. 7 is a schematic diagram of an implementation principle for processing the first output data of 6×6 dimensions into first target output data of 8×8 dimensions according to some embodiments of the present disclosure.

It should be understood that the first output data and the model set in the next model layer can be three-dimensional data. However, for ease of description and a more intuitive understanding of the dimension alignment process, FIG. 7 illustrates the dimension alignment process using two-dimensional data.

As shown in FIG. 7, the first output data is data with a dimension of 6×6 while the model set for the next model layer is data with a dimension of 8×8. Based on this, a 64-bit data storage area is allocated for the first output data. For ease of explanation, these 64 bits are referred to as bit 0 to bit 63. Therefore, data “1” in the first row and first column of the first output data should be located at bit 9, and data “2” in the first row and second column is located at bit 10. Following this pattern, data “6” in the last column of the first row of the first output data is located at bit position 14, while data “7” in the first column of the second row of the first output data should be located at bit position 17. That is, the number “6” in the last column of the first row of the first output data is not consecutive with the number “7” in the first column of the second row.

Based on this, since the model set of the next model layer has a dimension of 8×8, the first output processing module can construct an 8×8 all-zero matrix. It should be understood that, after mapping the all-zero matrix to the 64-bit data storage area corresponding to the first output data, the “0” in the first row and first column of the all-zero matrix corresponds to bit 0, the “0” in the first row and second column corresponds to bit 1, and so on. In the all-zero matrix, the elements from the second row, second column to the second row, seventh column correspond to the data in the first row, first column to the last column of the first output data. Correspondingly, as shown in FIG. 7, by skipping the areas in the all-zero matrix that do not require data filling, the positions in the all-zero matrix corresponding to the data in other positions of the first output data can be determined and filled. The zeros at the corresponding positions can be replaced with the data from the corresponding positions in the first output data.

Based on this, in the present disclosure, each data point in the first output data can be filled into the corresponding position on the all-zero matrix, resulting in the target output data shown in FIG. 7.

Of course, if the first output data has a dimension of 6×6×6, and the target data dimension has a dimension of 8×8×8, then only an all-zero matrix with a dimension of 8×8×8 needs to be constructed. The process of filling the first output data into the corresponding positions of an 8×8×8 all-zero matrix is similar and will not be described in detail here.

It should be understood that the above description uses the first output data as an example. The process of processing the second output data into the second target output data is similar and will not be described in detail here.

It should be understood that after constructing an all-zero matrix of the target data dimension using either the first or second output processing module, the next step is to fill the data from the first and second output data into the corresponding positions on the zero matrix. This allows for dimension alignment to be completed in a single operation. Compared to addressing and padding each data point in the first or second output data individually using software programs, the approach in the present disclosure significantly increases the efficiency of dimension alignment.

In the present disclosure, the first output processing module and the second output processing module can take various forms, which is not limited in the present disclosure.

For ease of understanding the technical solution described in the present disclosure, in the following example, both the first and second processors are neural processing units (NPUs), and the example is description in conjunction with FIG. 8. FIG. 8 is a schematic diagram of a component architecture of the model processing module in an application scenario according to some embodiments of the present disclosure.

The model processing module shown in FIG. 8 can be an artificial intelligence chip carrying two NPUs. In FIG. 8, the processing model handled by the NPU is a convolutional model. The model set for each convolutional layer in the convolutional model is the convolution kernel, which includes the weight matrix in the convolutional layer.

As shown in FIG. 8, the model processing module includes two NPUs of NPU1 and NPU2. Each NPU has both an input data transfer channel and a model data transfer channel connecting it to the SRAM memory.

Take NPU1 as an example, the data transfer channel between NPU1 and the SRAM memory includes, in sequence: an input direct memory access (DMA) controller, an input FIFO module, and an instruction acquisition controller.

The input DMA controller may be a DMA controller used for reading input data, which is equivalent to the access controller used for reading data in the previous embodiments. This FIFO module may be a FIFO module used for transmitting input data. The instruction acquisition controller is equivalent to the parameter receiving controller described earlier.

The model data transfer channel between NPU1 and the SRAM memory sequentially includes: a model DMA controller, a model FIFO module, and an instruction acquisition controller. The model DMA controller may be a DMA controller used for reading model data, and the model FIFO module may be a FIFO module used for transferring model data.

As shown in FIG. 8, there is also a connection between the input FIFO module corresponding to NPU2 and the input DMA controller corresponding to NPU1, allowing NPU2 to obtain the input data that the input DMA controller of NPU1 reads from the SRAM memory. In addition, there is a connection between the FIFO module of the model corresponding to NPU2 and the DMA controller of the model corresponding to NPU1, allowing NPU2 to obtain the model data read from the SRAM memory by the DMA controller of the model corresponding to NPU1.

In FIG. 8, each NPU includes 8 MAC units. For example, the 8 MAC units in NPU1 are denoted as MAC0-MAC7, while the 8 MAC units in NPU2 are denoted as MAC8-MAC15.

Each NPU is also connected to an output processing module, and between each NPU and the output processing module, there are data quantization units and mapping units. The data quantization unit may be configured to perform quantization processing on the output data, and the mapping unit may be configured to perform linear transformations and other processing based on the mapping relationship.

Each output processing module connected to the NPU also has a connection to the SRAM memory, allowing the output processing module to write the processed output data back to the SRAM memory.

In addition, the model processing module also includes control registers, through which NPU1 and NPU2 can be controlled to operate in either the first or second mode.

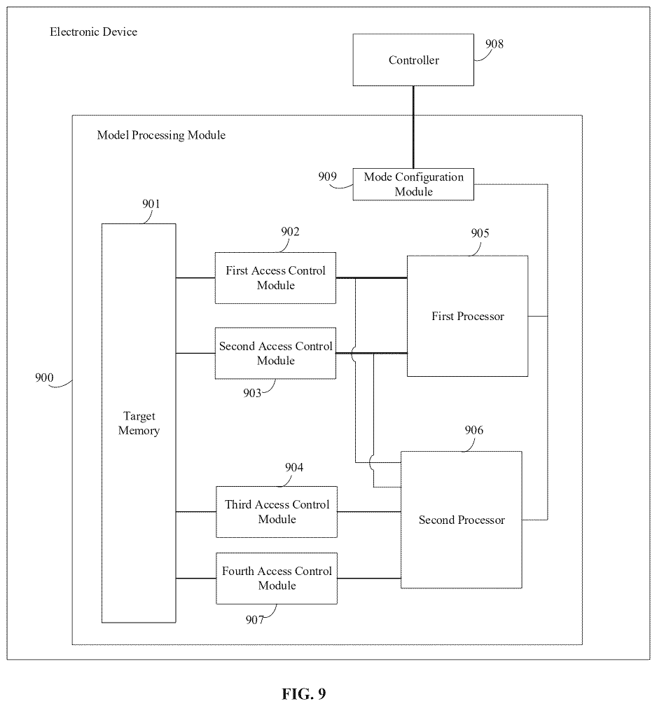

An embodiment of the present disclosure also provides an electronic device. FIG. 9 is a schematic structural diagram of an electronic device according to some embodiments of the present disclosure.

As shown in FIG. 9, the electronic device includes a model processing module 900. The model processing module 900 includes a target memory 901, a first access control module 902, a second access control module 903, a third access control module 904, a first processor 905, a second processor 906, and a fourth access control module 907.

In some embodiments, the target memory 901 may be configured to store a to-model set of a target model layer to be executed in the processing model, and a to-be-processed input data set of the target model layers, the model set including at least one model data, the input data set including at least one input data.

In some embodiments, the first access control module 902 may be configured to obtain first data of a first data type from the target memory, the first data type being either model data or input data.

In some embodiments, the second access control module 903 may be configured to obtain second data of a second data type from the target memory, the second data type being either model data or input data, the second data type being different from the first data type.

In some embodiments, the third access control module 904 may be configured to obtain third data of the second data type from the target memory.

In some embodiments, the first processor 905 may be configured to determine the first output data of the target model layer based on the first data and the second data.

In some embodiments, the second processor 906 may be configured to determine the second output data of the target model layer based on the first data and the third data.

Of course, the model processing module may also include a fourth access control module 907. For detail, reference can be made to the relevant description of the fourth access control module in the previous embodiments.

For a detailed description of the specific functions of each component of the model processing module, reference can be made to the relevant descriptions in the previous embodiments, which will not be repeated here.

In some embodiments, the electronic device may also include a controller 908. This controller can be a CPU or other control component, which is not limited in the present disclosure.

In some embodiments, the model processing module may also include a mode configuration module 909. The mode configuration module 909 may be configured to obtain a mode indication instruction sent by the controller, the mode indication instruction being used to indicate whether the model processing module is in a first mode or a second mode. In response to the mode indication instruction being an instruction to activate the first mode, the second processor may be instructed to access the first access control module and the third access control module. In response to the mode indication instruction being an instruction to activate the second mode, the second processor may be instructed to access the second access control module and the fourth access control module.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected based on an actual requirement to achieve the objectives of the solutions of the embodiments. In addition, in the accompanying drawings of the apparatus embodiments provided in this application, connection relationships between modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (e.g., a personal computer, a training equipment, a network equipment, etc.) to perform the methods described in embodiments of the present disclosure.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, communication apparatus, computing device, or data center to another website, computer, communication apparatus, computing device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a communication apparatus or a data center, integrating one or more usable media. The usable medium may be a magnetic medium (for example, a floppy disk, a hard disk, or a magnetic tape), an optical medium (for example, a DVD), a semiconductor medium (for example, a solid-state disk (SSD)), or the like.

What is claimed is:

1. A model processing module comprising:
a target memory, the target memory being used to store a model set of a target model layer to be processed in the processing module and an input data set to be processed by the target model layer, the model set including at least one model data, the input data set including at least one input data;
a first access control module, the first access control module being configured to obtain first data of a first data type from the target memory, the first data type being either the model data or the input data;
a second access control module, the second access control module being configured to obtain second data of a second data type from the target memory, the second data type being either the model data or the input data, the second data type being different from the first data type;
a third access control module, the third access control module being configured to obtain third data of the second data type from the target memory;
a first processor, the first processor being configured to determine first output data of the target model layer based on the first data and the second data; and
a second processor, the second processor being configured to determine second output data of the target model layer based on the first data and the third data.

2. The model processing module of claim 1, wherein:
in a first mode, the third access control module is configured to obtain the third data, and the second processor is configured to obtain the first data from the first access control module and the third data from the third access control module;
the model processing module further comprising:
a fourth access control module; and
in a second mode, the fourth access control module is configured to obtain fourth data of the first data type from the target memory, and the second processor is configured to obtain the second data from the second access control module and the fourth data from the fourth access control module, and determine third output data of the target model layer based on the second data and the fourth data.

3. The model processing module of claim 2, wherein:
the first data is first model data, the first model data belonging to at least one model data;
the second data is first input data, the first input data belonging to at least one input data;
in the first mode, the third data is second input data, the second input data belonging to at least one input data; and
in the second mode, the fourth data is second model data, the second model data belonging to at least one model data.

4. The model processing module of claim 2, further comprising:
a mode configuration module, the mode configuration module being configured to receive a mode indication instruction sent by a controller, the mode indication instruction being used to indicate whether the model processing module is in the first mode or the second mode, wherein:
in response to the mode indication instruction being an instruction to activate the first mode, the second processor is instructed to access the first access control module and the third access control module; and
in response to the mode indication instruction being an instruction to activate the second mode, the second processor is instructed to access the second access control module and the fourth access control module.

5. The model processing module of claim 3, wherein:
in the first mode, the target memory is used to store the model set of the target model layer to be executed in the processing module and a first input data subset to be processed by the target model layer in a first memory corresponding to the first processor, and to store a second input data subset to be processed by the target model layer in a second memory corresponding to the second processor, the first input data subset and the second input data subset constituting the input data set;
in the first mode, the first access control module is configured to obtain the first model data from the model set in the first memory;
in the first mode, the second access control module is configured to obtain the first input data from the first input data subset in the first memory; and
in the first mode, the third access control module is configured to obtain the second input data from the second input data subset in the second memory.

6. The model processing module of claim 3, wherein:
in the second mode, the target memory is used to store a first subset of models of the target model layer to be executed in the processing module and the input data subset to be processed by the target model layer in the first memory corresponding to the first processor, and to store a subset of models to be processed by the target model layer in a second memory corresponding to the second processor, the first subset of models and the second subset of models constituting the model set of the target model layer;
in the second mode, the first access control module is configured to obtain the first model data from the first subset of models;
in the second mode, the second access control module is configured to obtain the first input data from the input data set in the first memory; and
in the second mode, the fourth access control module is configured to obtain the second model data from the second subset of models in the second memory.

7. The model processing module of claim 2, wherein:
the first access control module includes a first access storage controller, a first first-in, first-out (FIFO) module, and a first parameter receiving controller;
the second access control module includes a second access storage controller, a second FIFO model, and a second parameter receiving controller;
the third access control module includes a third access storage controller, a third FIFO module, and a third parameter receiving controller;
the fourth access control module includes a fourth access storage controller, a fourth FIFO module, and a fourth parameter receiving controller;
in the first mode, the second processor is configured to obtain the first data from the first access storage controller through the fourth FIFO module and the fourth parameter receiving controller; and
in the second mode, the second processor is configured to obtain the second data from the second access storage controller through the third FIFO module and the third parameter receiving controller.

8. The model processing module of claim 1, further comprising:
a first output processing module and a second output processing module, wherein:
the first processor is further configured to output the first output data to the first output processing module, determine target data dimension corresponding to the model set in the next model layer after the target model layer in the processing model, and send the target data dimension to the first output processing module;
the first output processing module is configured to process the first output data into first target output data with the target data dimension;
the second processor is further configured to output the second output data to the second output processing module, determine the target data dimension corresponding to the model set in the next model layer, and send the target data dimension to the second output processing module; and
the second output processing module is configured to process the second output data into second target output data with the target data dimensions.

9. The model processing module of claim 8, wherein:
the first output processing module is configured to construct a first all-zero matrix of the target data dimension, fill the data in the first output data into corresponding positions in the first all-zero matrix based on the positions of each piece of data in the first output data corresponding to the first all-zero matrix to obtain the first target output data; and
the first output processing module is configured to construct a second all-zero matrix of the target data dimension, fill the data in the second output data into corresponding positions in the second all-zero matrix based on the positions of each piece of data in the second output data corresponding to the second all-zero matrix to obtain the second target output data.

10. An electronic device comprising a model processing module, the model processing module includes:
a target memory, the target memory being used to store a model set of a target model layer to be processed in the processing module and an input data set to be processed by the target model layer, the model set including at least one model data, the input data set including at least one input data;
a first access control module, the first access control module being configured to obtain first data of a first data type from the target memory, the first data type being either the model data or the input data;
a second access control module, the second access control module being configured to obtain second data of a second data type from the target memory, the second data type being either the model data or the input data, the second data type being different from the first data type;
a third access control module, the third access control module being configured to obtain third data of the second data type from the target memory;
a first processor, the first processor being configured to determine first output data of the target model layer based on the first data and the second data; and
a second processor, the second processor being configured to determine second output data of the target model layer based on the first data and the third data.

11. The electronic device of claim 10, wherein:
in a first mode, the third access control module is configured to obtain the third data, and the second processor is configured to obtain the first data from the first access control module and the third data from the third access control module;
the model processing module further comprising:
a fourth access control module; and
in a second mode, the fourth access control module is configured to obtain fourth data of the first data type from the target memory, and the second processor is configured to obtain the second data from the second access control module and the fourth data from the fourth access control module, and determine third output data of the target model layer based on the second data and the fourth data.

12. The electronic device of claim 11, wherein:
the first data is first model data, the first model data belonging to at least one model data;
the second data is first input data, the first input data belonging to at least one input data;
in the first mode, the third data is second input data, the second input data belonging to at least one input data; and
in the second mode, the fourth data is second model data, the second model data belonging to at least one model data.

13. The electronic device of claim 11, further comprising:
a mode configuration module, the mode configuration module being configured to receive a mode indication instruction sent by a controller, the mode indication instruction being used to indicate whether the model processing module is in the first mode or the second mode, wherein:
in response to the mode indication instruction being an instruction to activate the first mode, the second processor is instructed to access the first access control module and the third access control module; and
in response to the mode indication instruction being an instruction to activate the second mode, the second processor is instructed to access the second access control module and the fourth access control module.

14. The electronic device of claim 12, wherein:
in the first mode, the target memory is used to store the model set of the target model layer to be executed in the processing module and a first input data subset to be processed by the target model layer in a first memory corresponding to the first processor, and to store a second input data subset to be processed by the target model layer in a second memory corresponding to the second processor, the first input data subset and the second input data subset constituting the input data set;
in the first mode, the first access control module is configured to obtain the first model data from the model set in the first memory;
in the first mode, the second access control module is configured to obtain the first input data from the first input data subset in the first memory; and
in the first mode, the third access control module is configured to obtain the second input data from the second input data subset in the second memory.

15. The electronic device of claim 12, wherein:
in the second mode, the target memory is used to store a first subset of models of the target model layer to be executed in the processing module and the input data subset to be processed by the target model layer in the first memory corresponding to the first processor, and to store a subset of models to be processed by the target model layer in a second memory corresponding to the second processor, the first subset of models and the second subset of models constituting the model set of the target model layer;
in the second mode, the first access control module is configured to obtain the first model data from the first subset of models;
in the second mode, the second access control module is configured to obtain the first input data from the input data set in the first memory; and
in the second mode, the fourth access control module is configured to obtain the second model data from the second subset of models in the second memory.

16. The electronic device of claim 11, wherein:
the first access control module includes a first access storage controller, a first first-in, first-out (FIFO) module, and a first parameter receiving controller;
the second access control module includes a second access storage controller, a second FIFO model, and a second parameter receiving controller;
the third access control module includes a third access storage controller, a third FIFO module, and a third parameter receiving controller;
the fourth access control module includes a fourth access storage controller, a fourth FIFO module, and a fourth parameter receiving controller;
in the first mode, the second processor is configured to obtain the first data from the first access storage controller through the fourth FIFO module and the fourth parameter receiving controller; and
in the second mode, the second processor is configured to obtain the second data from the second access storage controller through the third FIFO module and the third parameter receiving controller.

17. The electronic device of claim 10 further comprising a first output processing module and a second output processing module, wherein:
the first processor is further configured to output the first output data to the first output processing module, determine target data dimension corresponding to the model set in the next model layer after the target model layer in the processing model, and send the target data dimension to the first output processing module;
the first output processing module is configured to process the first output data into first target output data with the target data dimension;
the second processor is further configured to output the second output data to the second output processing module, determine the target data dimension corresponding to the model set in the next model layer, and send the target data dimension to the second output processing module; and
the second output processing module is configured to process the second output data into second target output data with the target data dimensions.

18. The electronic device of claim 17, wherein:
the first output processing module is configured to construct a first all-zero matrix of the target data dimension, fill the data in the first output data into corresponding positions in the first all-zero matrix based on the positions of each piece of data in the first output data corresponding to the first all-zero matrix to obtain the first target output data; and
the first output processing module is configured to construct a second all-zero matrix of the target data dimension, fill the data in the second output data into corresponding positions in the second all-zero matrix based on the positions of each piece of data in the second output data corresponding to the second all-zero matrix to obtain the second target output data.

19. A model processing method comprising:
storing, by a target memory, a model set of a target model layer to be processed in the processing module and an input data set to be processed by the target model layer, the model set including at least one model data, the input data set including at least one input data;
obtaining, by a first access control module, first data of a first data type from the target memory, the first data type being either the model data or the input data;
obtaining, by a second access control module, second data of a second data type from the target memory, the second data type being either the model data or the input data, the second data type being different from the first data type;
obtaining, by a third access control module, third data of the second data type from the target memory;
determining, by a first processor, first output data of the target model layer based on the first data and the second data; and
determining, by a second processor, second output data of the target model layer based on the first data and the third data.

20. The model processing method of claim 19, wherein:
in a first mode, the third access control module is configured to obtain the third data, and the second processor is configured to obtain the first data from the first access control module and the third data from the third access control module;
the model processing method further comprising:
in a second mode, obtaining, by a fourth access control module, fourth data of the first data type from the target memory, the second processor being configured to obtain the second data from the second access control module and the fourth data from the fourth access control module, and to determine third output data of the target model layer based on the second data and the fourth data.
